(19) United States
(12) Patent Application Publication
(10) Pub. No.: US 2014/0038933 A1
(43) Pub. Date: Feb. 6, 2014

(54) Composition and Method For Preventing Discoloration of Pyrithione Containing Compositions

(71) Applicant: Arch Chemicals, Inc., Atlanta, GA (US)

(72) Inventors: George Polson, Jasper, GA (US); Jody Jourden, Atlanta, GA (US); Denise B. Taylor, Cumming, GA (US); Yongcheng Ji, Alpharetta, GA (US)

(73) Assignee: Arch Chemicals, Inc., Atlanta, GA (US)

(21) Appl. No.: 13/954,285

(22) Filed: Jul. 30, 2013

Related U.S. Application Data
(60) Provisional application No. 61/677,704, filed on Jul. 31, 2012.

(51) Int. Cl. A01N 25/22; A01N 55/02

(52) U.S. Cl. CPC A01N 25/22; A01N 55/02
USPC 514/188

(57) ABSTRACT

The present invention provides a composition containing a pyrithione compound and a pyranone compound and a method of reducing discoloration of compositions containing pyrithione compounds. The composition may be a soap composition.

### RELATED APPLICATIONS

This application claims filing benefit of U.S. Provisional Patent Application Ser. No. 61/677,704, filed on Jul. 31, 2012, and which is incorporated herein in its entirety.

### FIELD OF THE INVENTION

The present invention generally relates to a composition containing a pyrithione compound and a pyranone compound and a method of reducing discoloration of compositions containing pyrithione compounds.

### BACKGROUND OF THE INVENTION

Metal salts of pyrithiones are known in the art to have biocidal activity and have been widely used as fungicides and bacteriocides. In particular, polyvalent metal salts of pyrithione (also known as 1-hydroxy-2-pyridinethione; 2-pyridinethiol-1-oxide; 2-pyridinethione; 2-mercaptopyridine-N-oxide; pyridinethione; and pyridinethione-N-oxide) are known to be effective biocidal agents. As such, polyvalent metal salts of pyrithione compounds have been used in a wide variety of compositions including personal care compositions, such as cosmetics, and anti-dandruff shampoos; material protection products, such as paints, adhesives, caulks and sealants; plastics and metal working fluids. In addition, the use of polyvalent metal salts of pyrithione is generally growing.

One significant problem encountered in the manufacture of finished formulations (compositions) containing pyrithione compounds is the interaction of extraneous iron salts that may be introduced to the formulations from raw materials or processing equipment. In the presence of ferric ion, sodium pyrithione or zinc pyrithione-containing compositions tend to turn blue even though the ferric ion is present in mere trace amounts. This blue discoloration is undesirable for aesthetic reasons, as well as for functional reasons relating to unwanted color in the resulting composition. Since the aesthetics of shampoos, paints, adhesives, caulks and sealants normally require certain desirable colors, and since the formulators of such products go to great lengths to achieve specific color effects, any ingredient which causes the formulation to vary much from a desired white or colorless hue may make the colorant formulators' task very difficult. More specifically, when attempting to utilize pyrithione as an antimicrobial agent in fully-formulated shampoos, water-based paints, paint bases (i.e., the partially formulated paint before pigment addition), adhesives, caulks and sealants, an unwanted color from the additive can adversely affect the color of the formulated product or change the intended color of the finished product. As a result, this undesired color might make the formulations undesirable for their intended use.

In the past, various solutions to the blue discoloration problem have been proposed. By way of illustration, U.S. Pat. Nos. 6,096,122 and 5,939,203 and 5,883,154 and 5,562,995 all disclose solutions to the above problem by addition of inorganic compounds of zinc. U.S. Pat. Nos. 4,957,658 and 4,818,436 disclose solutions to the above-discussed discoloration problem by adding to the paint or functional fluid an alkali metal or alkaline earth metal salt of 1-hydroxyethane-1,1-diphosphonic acid. Although these patents propose solutions to the discoloration problem, these solutions are not always as cost effective or do not work at a broad pH range (4-11). In some situations, these solutions may not be as permanent as might be desired.

There is a need in the art for an economical and environmentally friendly solution to the discoloration problem that will allow pyrithione compounds to be used in the presence of iron ions which will work in a broad pH range and uses relatively low levels additives which are generally considered to be safe.

### SUMMARY OF THE INVENTION

Generally stated, the present invention provides a cost effective composition containing a pyrithione compound which has a reduced discoloration from the presence of iron ions in the composition.

In one embodiment of the present invention, provided is a biocidal composition containing a pyrithione compound in an amount effective to provide biocidal properties to the composition and a pyranone compound in an amount effective to reduce discoloration of the biocidal composition due the presence of iron ions in the composition.

In another embodiment of the present invention, provided is a method for reducing discoloration of a pyrithione-containing composition due to the presence of an iron ion, said method comprises adding a pyranone compound to the pyrithione-containing composition in an amount effective to complex iron ions introduced to the composition from impurities present in raw materials used to make the composition or from the processing equipment.

In a particular embodiment of the present invention, the present invention is directed to a soap composition which contains a pyrithione compound, a pyranone compound and optionally a co-chelator.

By providing the pyrithione containing composition with a pyranone compound, the effects of the presence of iron ions in the composition with respect to discoloration are reduced or even eliminated.

### DEFINITIONS

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As used herein, the term “pyrithione containing composition” is intended to mean a composition containing a pyrithione compound or a pyrithione metal salt.

### DETAILED DESCRIPTION OF THE INVENTION

The present invention relates to a method of adding iron chelators that prevent chelation of pyrithione compounds or pyrithione salts with extraneous sources of iron from raw materials or processing equipment, thereby preventing aesthetically undesirable colors in finished products, such as a blue-black colors in finished products. Generally, the finished products are prepared from a biocidal composition containing the pyrithione compound or pyrithione salt. Since pyrithione itself is a very good chelator of free iron species, there needs to be another chelator that can competitively chelate with free iron as well as minimize the ionization of pyrithione complexes. The present invention relates to both the composition containing the pyrithione compounds as well as the method of reducing discoloration of a composition of containing a pyrithione compound.

Pyrithione compounds (also known as 1-hydroxy-2-pyridinethione; 2-pyridinethiol-1-oxide; 2-pyridinethione; 2-mercaptopyridine-N-oxide; pyridinethione; and pyridinethione-N-oxide) are known in the art and are known to be effective biocidal agents. In particular, polyvalent metal salts of pyrithione compounds are generally used as biocidal agents. Synthesis of polyvalent pyrithione salts are described in U.S. Pat. No. 2,809,971 to Berstein et al., each hereby incorporated by reference. Other patents disclosing similar compounds and processes for making them include, for example, U.S. Pat. No. 2,786,847; U.S. Pat. No. 3,589,999; U.S. Pat. No. 3,590,035; U.S. Pat. No. 3,773,770. Complexes of 1-hydroxy-2-pyridinethione can be found in the publication by Robinson, M. A. Journal of Inorganic and Nuclear Chemistry (1964), 26(7), 1277-81. Suitable metal salts or complexes of pyrithiones, such as zinc, copper, bismuth, tin, cadmium, magnesium, aluminum, and zirconium may be used in the composition. Generally, zinc salt of 1-hydroxy-2-pyridinethione, known in the art as zinc pyrithione, is the most widely used. Commercially available pyrithione salts suitable herein include zinc pyrithione available from Arch Chemicals, Inc.

It has been discovered that a class of pyranone compounds are very useful iron chelators and that pyranone compounds effectively competitively chelate with free iron as well as minimize the ionization of pyrithione complexes in biocidal compositions. By chelating the iron with the pyranone compound, the resulting composition will tend not to be discolored by the formation of pyrithione complexes with the iron. Various examples of pyranone which are useful to prevent or reduce discoloration include, but are not limited to, pyranones of structure (I):

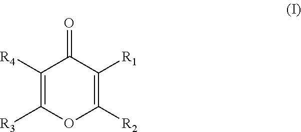

where R₁ R₂, R₃ and R₄ are each independently a H, OH, (C═O) alkyl group or alkyl group which may be substituted with an halogen, a hydroxyl group and the like.

Specific examples of pyranones which may be used in the present invention include 3-acetyl-6-methyl-2H-pyranone (dehydroacetic acid or DNA) having the structure (II):

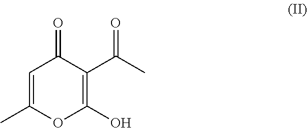

Kojic acid having the structure (III):

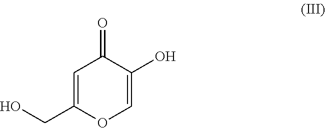

or
Maltol having the structure (IV):

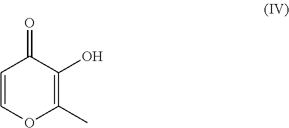

In addition, the pyranone compounds may be a salt of the pyranone. Suitable salts include metal salts, such as zinc salts, calcium salts, magnesium salts and sodium salts. Generally, zinc salts and sodium salts are used.

By adding the pyranone compound, or salt thereof, to a composition containing a pyrithione compound or a pyrithione salt, it is believed that any iron ions present in the composition will chelate with the pyranone compound and will avoid the chelation of the iron ions with the pyrithione compound or pyrithione salt, thereby reducing or avoiding the discoloration of the resulting composition containing the pyrithione compound or pyrithione salt.

In addition to the pyranone compound, an iron co-chelator may be added to the composition. Suitable iron co-chelators include any compounds that will chelate iron and will not adversely affect the intended purpose of the composition. Exemplary iron ion co-chelators include, for example, hyroxyethylidene diphosphonic acid, ethylene diamine tetraacetic acid and its various analogs, salts of each of the proceeding compounds or a mixture thereof. Suitable salts include, for example, zinc salts, calcium salts, magnesium salts or sodium salts of these co-chelators. It has been discovered that the addition of the co-chelator can further help reduce the discoloration of the resulting composition.

Generally, in a composition containing a pyrithione compound or a pyrithione salt, the composition may contain up to about 10% by weight, based on the total weight of the composition of the pyrithione compound or a pyrithione salt as the effective amount. Higher weight percentages may be used, if necessary. Typically, the composition will contain from about 0.001% to 5.0% by weight, based on the total weight of the composition, of the pyrithione or pyrithione metal salt. In most applications the pyrithione or pyrithione salt is present in an amount between about 0.01% to about 3% by weight, based on the total weight of the composition.

In a composition containing a pyrithione or a pyrithione complex, the composition may contain up to about 10% by weight, based on the total composition, of the pyranone compound or pyranone salt as the effective amount. Higher weight percentages may be used, if necessary. Typically, the composition will contain from about 0.001% to 5.0% by weight, based on the total weight of the composition, of the pyranone or pyranone salt. In most applications, the pyranone or pyranone salt is present in an amount between about 0.01% to about 3% by weight, based on the total weight of the composition.

The iron co-chelator may be present in an amount up to about 10% by weight, based on the total composition, as the effective amount. Higher weight percentages may be used if necessary. Typically, the composition will contain from about 0.001% to 5.0% by weight, based on the total weight of the composition, of the iron co-chelator. In most applications, the iron co-chelator is present in an amount between about 0.01% to about 3% by weight, based on the total weight of the composition. Typically, the weight ratio of the pyranone compound or salt thereof to the iron co-chelator is in the range of about 0.01:10 to about 10:0.01, more typically in the range of about 0.01:1 to about 1:0.01.

The pyrithione-containing compositions of the present invention can be used in a wide variety of uses including, for example, a soap, a shampoo, a hand sanitizer, a deodorant, a metal working fluid, a wood preservative, a paint, a coating, or a plastic precursor. The balance of the composition, apart from the pyrithione compound or salt thereof, the pyranone compound or salt thereof, and/or the iron co-chelator are components which make the composition useful for its intended purpose. For example, a soap composition having biocidal properties will contain ingredients typically found in soap. These types of compositions are well known in the art.

An exemplary soap composition will generally contain a soap component, a pH adjusting agent, and other additives. Suitable soap components include, for example alkali metal or alkanol ammonium salts of alkane- or alkene monocarboxylic acids. Alkali metals suitable include, sodium, magnesium, potassium, calcium, and alkanol ammonium salts include mono-, di- and tri-ethanol ammonium cations. Combinations thereof are also suitable. Generally, soaps having the fatty acid distribution of coconut oil may provide the lower end of the broad molecular weight range. Those soaps having the fatty acid distribution of peanut or rapeseed oil, or their hydrogenated derivatives, may provide the upper end of the broad molecular weight range.

Generally, soaps having the fatty acid distribution of tallow and vegetable oil are used. More particularly, the vegetable oil is selected from the group consisting of palm oil, coconut oil, palm kernel oil, palm oil stearine, and hydrogenated rice bran oil, or mixtures thereof, since these are among the more readily available fats. Especially preferred are palm oil stearine, palm kernel oil, and/or coconut oil. The proportion of fatty acids having at least 12 carbon atoms in coconut oil soap is about 85%. This proportion will be greater when mixtures of coconut oil and fats such as tallow, palm oil, or non-tropical nut oils or fats are used, wherein the principal chain lengths are C₁₆ and higher.

Soaps may be made by the classic kettle boiling process or modern continuous soap manufacturing processes wherein natural fats and oils such as tallow or coconut oil or their equivalents are saponified with an alkali metal hydroxide using procedures well known to those skilled in the art. Alternatively, the soaps may be made by neutralizing fatty acids, such as lauric (C₁₂), myristic (C₁₄), palmitic (C₁₆), or stearic (C₁₈) acids with an alkali metal hydroxide or carbonate.

The pH of the present bar soap is greater than or equal to 10. Soap comprises a pH adjusting agent in a sufficient amount to attain the above mentioned pH. The pH adjusting agents useful for the present composition includes alkalizing agents. Suitable alkalizing agents include, for example, ammonia solution, triethanolamine, diethanolamine, monoethanolamine, potassium hydroxide, sodium hydroxide, sodium phosphate dibasic, soluble carbonate salts, ammonia solution, triethanolamine, diethanolamine, monoethanolamine, potassium hydroxide, sodium hydroxide, sodium phosphate dibasic, soluble carbonate salts and combinations thereof.

Other ingredients may be present in the soap, including surfactants, structurants, colorants, moisturizers, skin conditioners, brighteners, opacifiers, fragrances, perfumes, and other such additives conventionally added to soaps.

To add the pyranone compound or salt thereof to the pyrithione containing composition, the pyranone compound or salt thereof is mixed with the components of the composition, including the pyrithione compound. The pyranone compound or salt may be added as a solution, aqueous slurry, or as a solid.

### EXAMPLES

### Example 1

Solutions were prepared according to TABLE 1 in water with a final concentration of 0.5% zinc pyrithione (ZPT), 0.25% chelator or its Zn salt, and 125 ppm Fe(III) at a pH of 10-10.3. ZPT was weighed into 100 mL sample containers. To this was added 20 g of H₂O and the chelator or chelators as shown in TABLE 1. In TABLE 1, DHA is acetyl-6-methyl-2H-pyranone (dehydroacetic acid) (Geogard 111A), DHA-Zn is a zinc salt of acetyl-6-methyl-2H-pyranone, Wayhib-Zn is a commercial hyroxyethylidene diphosphonic acid (HEDP) zinc salt. Each of DHA, and DHA-Zn were added as solids. HEDP-Zn, which is a zinc salt of hyroxyethylidene diphosphonic acid (sold under the trade name Wayhib-Zn), were added as solutions in which the Zn-salt was pre-formed in an aqueous solution then added to the sample. The formulations were then sonicated for two minutes and then adjusted to a pH of approximately 10.0 using 1.0 M NaOH. The remaining amount of water was then added to each sample and the pH was adjusted again if needed. The samples were placed on a shaker for 30 minutes to ensure thorough mixing. Following the 30 minutes, 0.5 g of a FeCl₃ stock was added to give a final concentration of 125 ppm Fe(III) in each solution.

TABLE 1

| | | SAMPLE | | | |
|---|---|---|---|---|---|
| | | 1 | 2 | 3 | 4 |
| wt % | ZPT | 0.50 | 0.50 | 0.50 | 0.50 |
| | DHA | | 0.25 | | |
| | DHA-Zn | | | 0.25 | 0.125 |
| | Wayhib-Zn | | | | 0.125 |
| g | ZPT(48%) | 0.42 | 0.42 | 0.42 | 0.42 |
| | DHA | | 0.10 | | |
| | DHA-Zn | | | 0.10 | 0.05 |
| | Wayhib-Zn | | | | 1.52 |
| | (3.3%) | | | | |
| | Fe (10000 ppm | 0.50 | 0.50 | 0.50 | 0.50 |
| | stock) | | | | |
| | H2O | 39.08 | 38.98 | 38.98 | 37.52 |
| batch total (g) | | 40.00 | 40.00 | 40.00 | 40.00 |
| Final pH | | 10.30 | 10.06 | 10.08 | 10.15 |
| Color | | Green/Brown | Light | Light | Pale |
| | | | Beige | Beige | Yellow |

### Example 2

A melt and pour soap base containing the following ingredients coconut oil, palm oil, safflower oil, glycerin (kosher, of vegetable origin), purified water, sodium hydroxide (saponifying agent), sorbitol (moisturizer), sorbitan oleate (emulsifier), soy bean protein (conditioner), titanium dioxide (mineral whitener used in opaque soaps) was heated and melted. Combinations of ZPT with iron chelators were formulated into a melt and pour soap base and the resulting color of the compositions were compared to the melt and pour soap base as shown in Table 2. Samples A and B containing the formulation shown in the Table 2 show similar coloring as that of the control melt and pour soap base.

TABLE 2

| | | Sample A | Sample B |
|---|---|---|---|
| wt % | ZPT | 0.500 | 0.500 |
| | DHA-Zn | 0.125 | 1.000 |
| | HEDP-Zn | 0.125 | 0.500 |
| g | ZPT (48%) | 0.417 | 0.417 |
| | DHA-Zn | 0.050 | 0.400 |
| | HEDP-Zn | 1.563 | 6.250 |
| | (3.3%) | | |
| | Soap Base | 37.971 | 32.933 |
| | Fe (III) | 10 ppm | 125 ppm |
| batch total (g) | | 40.00 | 40.00 |
| Color | | White | White |

The soap composition is essentially the same color as the base without the ZPT and the chelator composition.

### Example 3

Samples of ZPT with iron chelators formulated into a melt and pour soap base used in Example 2. After melting of the soap base in a beaker, Fe(III) was added as a solution of FeCl₃ in water producing a light yellow color. This was followed by the addition of iron chelators and then finally ZPT in the amounts shown in Table 3. Samples were poured into vials after color changes had stopped. The composition of each sample is shown in TABLE 3, as is the resulting color of the soap when iron is present. Color was observed with the naked eye of the soap in the vials.

TABLE 3

| | Sample 1 | Sample 2 | Sample 3 | Sample 4 |
|---|---|---|---|---|
| Amounts of | 0.5% ZPT | 0.5% ZPT | 0.5% ZPT | 0.5% ZPT |
| components in | 125 ppm | 0.05% HEDP- | 0.125% HEDP- | 0.20% HEDP-Zn |
| Soap | Fe(III) | Zn | Zn | 0.05% DHA-Zn |
| | | 0.20% DHA-Zn | 0.125% DHA-Zn | 125 ppm Fe(III) |
| | | 125 ppm Fe(III) | 125 ppm Fe(III) | |
| Color of | Grey with | Light Grey | White | White with light |
| resulting soap | black spots | | | orange specks |

As shown in TABLE 3, a series of formulations using DHA-Zn and HEDP-Zn combinations were formed. When using DHA-Zn as the chelator, increasing HEDP-Zn to DHA-Zn lessens the grey coloring. The combination of chelators improves the overall color of the soap composition, lessening the effect of iron ions on the pyrithione compound. However, as can be seen, the addition of the DHA and HEDP combination helps reduce the color form an unacceptable grey with black spots to a light grey, white with some specks of other colors. These colors are considered acceptable, versus the soap without the DHA-Zn and HEDP-Zn additives.

Although the present invention has been described with reference to various embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A method for reducing discoloration of a pyrithione-containing composition due to the presence of an iron ion, said method comprising:
adding a pyranone compound to the pyrithione-containing composition in an amount effective to complex iron ions introduced to the composition from impurities present in raw materials used to make the composition or from the processing equipment.

2. The method according to claim 1, wherein the pyranone compound comprises 3-acetyl-6-methyl-2H-pyranone or a salt thereof.

3. The method according to claim 2, wherein the salt of 3-acetyl-6-methyl-2H-pyranone comprises a sodium or a zinc salt.

4. The method according to claim 2, wherein the 3-acetyl-6-methyl-2H-pyranone is added to the pyrithione-containing composition as a solid or as an aqueous slurry.

5. The method according to claim 1, wherein the pyrithione-containing composition is a soap, a shampoo, a hand sanitizer, a deodorant, a metal working fluid, a wood preservative, a paint, a coating, or a plastic precursor.

6. The method according to claim 1, wherein the pyranone is added in a range of 0.001% to 5% by weight, based on the total weight of the composition.

7. The method according to claim 1, further comprising adding an iron co-chelator to the pyrithione-containing composition.

8. The method according to claim 7, said iron co-chelator comprising a compound selected from the group consisting of hydroxyethylidene diphosphonic acid, ethylene diamine tetraacetic acid, salts of each of the proceeding compounds and mixtures thereof.

9. The method according to claim 7, wherein the weight ratio of the pyranone compound to the iron co-chelator is in the range of about 0.01:1 to about 1:0.01.

10. The method according to claim 1, said pyrithione containing-composition comprising sodium pyrithione, zinc pyrithione or a mixture thereof.

11. The method according to claim 1, said pyrithione containing composition comprising a pyrithione in an amount between about 0.001% to about 5.0% by weight of the composition.

12. A biocidal composition comprising:
a pyrithione compound or a pyrithione salt in an amount effective to provided biocidal properties to the composition;
a pyranone compound; and
an iron co-chelator,
wherein each of the pyranone compound and the iron co-chelator are present in an amount effective to reduce or eliminate discoloration of the biocidal composition due to the presence of an iron ion.

13. The composition according to claim 12, said pyrithione compound comprising sodium pyrithione, zinc pyrithione or a mixture thereof.

14. The composition according to claim 12, said pyranone compound comprising 3-acetyl-6-methyl-2H-pyranone or a salt thereof.

15. The composition according to claim 14, said salt of 3-acetyl-6-methyl-2H-pyranone comprising a sodium or a zinc salt.

16. The composition according to claim 12, said iron chelator comprising a compound selected from the group consisting of hydroxyethylidene diphosphonic acid, ethylene diamine tetraacetic acid and its analogs, salts of each of the proceeding compounds and mixtures thereof.

17. The composition according to claim 16, wherein the weight ratio of the pyranone compound to the iron co-chelator is in the range of about 0.01:1 to about 1:0.01.

18. The composition according to claim 17, said pyrithione comprising between about 0.001% to about 5.0% by weight of the composition, said pyranone compound comprising between about 0.001% to about 5.0% by weight of the composition and said iron co-chelator comprising about 0.001% to about 5.0% by weight of the composition.

19. The composition according to claim 18, said composition comprising a balance of components which give the composition its properties for its intended purpose and the composition is a soap, a shampoo, a hand sanitizer, a deodorant, a metal working fluid, a wood preservative, a paint, a coating, or a plastic precursor.

20. The composition according to claim 19, wherein the composition is a soap composition.
